(19) United States
(12) Patent Application Publication
(10) Pub. No.: US 2026/0214002 A1
(43) Pub. Date: Jul. 23, 2026

(54) SYSTEMS AND METHODS FOR CREATING CLUSTERS OF NETWORK FUNCTIONS IN A WIRELESS NETWORK

(71) Applicant: Verizon Patent and Licensing Inc., Basking Ridge, NJ (US)

(72) Inventors: Deepak MAJJIGA, Irving, TX (US); Jason T. WRIGHT, Novi, MI (US)

(73) Assignee: Verizon Patent and Licensing Inc., Basking Ridge, NJ (US)

(21) Appl. No.: 19/035,085

(22) Filed: Jan. 23, 2025

(51) Int. Cl. H04L 41/084; H04L 41/0893

(52) U.S. Cl. CPC H04L 41/0846; H04L 41/0893

(57) ABSTRACT

In some implementations, a device may create a cluster of network functions from a plurality of network functions in a wireless network, wherein the cluster of network functions includes one or more network functions that are associated with a same network functionality. The device may modify one or more thresholds associated with the cluster of network functions, wherein each network function in the cluster of network functions is associated with a respective threshold of the one or more thresholds. The device may synchronize one or more configurations between the one or more network functions in the cluster of network functions.

### BACKGROUND

Communication systems are widely deployed to provide various telecommunication services such as telephony, video, data, messaging, and broadcasts. A network may include one or more network devices that support communication for wireless communication devices.

### BRIEF DESCRIPTION OF THE DRAWINGS

FIG. 1 is a diagram of an example associated with an adaptive global configuration management framework.

FIG. 2 is a diagram of an example associated with static homogeneous clustering.

FIG. 3 is a diagram of an example associated with static heterogeneous clustering.

FIG. 4 is a diagram of an example associated with dynamic hybrid clustering.

FIG. 5 is a diagram of an example associated with a threshold manager.

FIG. 6 is a diagram of an example associated with a configuration manager.

FIG. 7 is a diagram of an example environment in which systems and/or methods described herein may be implemented.

FIG. 8 is a diagram of example components of one or more devices of FIG. 7.

FIG. 9 is a flowchart of an example process associated with creating clusters of network functions in a wireless network.

### DETAILED DESCRIPTION OF EXAMPLE EMBODIMENTS

The following detailed description of example implementations refers to the accompanying drawings. The same reference numbers in different drawings may identify the same or similar elements.

A wireless communications network may include various network functions and/or transport functions. A network function may be an entity that provides a specific functionality. A network function may include a user plane function (UPF), a session management function (SMF), a packet gateway (PGW), a mobility management entity (MME), a serving gateway (SGW), a virtualized distributed unit (VDU), and/or a virtualized centralized unit (VCU). A transport function may be an entity that facilitates a transfer of data. A transport function may include a router, a switch, a multi-layer switch, and/or a firewall.

A wireless communications network may suffer from an outage, which may be due to various causes. For example, the outage may be due to traffic overload, equipment failure, software failure, configuration errors, power failures, and/or cyber-attacks. The outage may affect different network functions in the wireless communications network. For example, the outage may only affect specific types of network functions.

As an example, a wireless communications network may include a first diameter routing agent (DRA), a second DRA, and a third DRA. Each DRA may provide real-time routing capabilities to ensure that messages are routed to appropriate elements in the wireless communications network. The first DRA may be a primary device, the second DRA may be a secondary device, and the third DRA may be a tertiary device. The first DRA may fail and become inoperable, so all traffic may automatically be diverted to a second DRA. Due to a resulting traffic surge at the second DRA, the second DRA may also fail due to static thresholds. For example, the second DRA may be associated with the static thresholds, and when the static thresholds are exceeded due to traffic from the first DRA being routed to the second DRA, the second DRA may fail. Due to the failure of the second DRA, traffic may be automatically routed to the third DRA. During a routing of traffic from the second DRA to the third DRA, or during a routing of traffic from the third DRA to other network elements, certain required routes may be missing, which may lead to a service outage. The service outage may due to the static thresholds in routing network functions (e.g., the second DRA), which may not be able to adapt to traffic demand. The service outage may also due to missing configurations among the first DRA, the second DRA, and the third DRA. The service outage may also result due to unsynchronized route configurations among the first DRA, the second DRA, and the third DRA. For example, when a route configuration is changed in the first DRA, but the change is not propagated to the second DRA and the third DRA, the DRAs may be out of synchronization and static with thresholds. A presence of static thresholds for certain network functions and/or a presence of incomplete/unsynchronized configurations among network functions may lead to such outages, thereby degrading an overall system performance.

In some implementations, a wireless communications network may employ an adaptive global configuration management framework. The adaptive global configuration management framework may be responsible for cluster management. The cluster management may involve discovering network functions and creating clusters with similar functionalities. For example, a first cluster may be associated with a first type of network function, a second cluster may be associated with a second type of network function, and so on. For example, DRAs may form one cluster, VDUs may form another cluster, and so on. Different clusters may be associated with different network functions. A given cluster may include different network functions with similar functionalities, or the given cluster may include the same type of network functions (e.g., network functions all having the same functionality). The adaptive global configuration management framework may be responsible for threshold management. The threshold management may involve dynamically modifying thresholds in all network functions within the given cluster based on load or other conditions. The thresholds may include routing and traffic control thresholds. The adaptive global configuration management framework may be responsible for configuration management. The configuration management may involve synchronizing configurations in all network functions within the given cluster. For example, a first network function in the given cluster and a second network function in the given cluster may be synchronized with the same configuration.

In some implementations, by supporting the adaptive global configuration management framework that is responsible for creating clusters of network functions with similar functionalities, dynamically modifying thresholds for all network functions in the given cluster, and/or synchronizing configurations between network functions in the given cluster, adaptively altered configurations may be supported in the wireless communications network. All network functions in the given cluster may support the same configuration, which may be due to a synchronization of configurations between network functions in the same cluster. Network functions in the given cluster may support dynamic thresholds, which may be modified when certain network functions in the given cluster fail. Management of the given cluster may be supported at a global level. Functionalities may not need to be configured for individual network functions, but rather functionalities may be configured for clusters of network functions at the global level, thereby saving resources and improving an overall system performance. Network functions within a cluster may work together, such that if one network function within the cluster becomes associated with a failure, other network functions within the cluster may handle a load of the network function associated with the failure.

As an example, a given cluster may include a first network function and a second network function. When the first network function becomes associated with a failure, the second network function may handle traffic associated with the first network function. The second network function may be configured in a similar manner as the first network function, which may be due to synchronized configurations between the first network function and the second function. The second network function may support dynamically modified thresholds, which may be needed due to the failure of the first network function. Since the first network function and the second network function are clustered together due to similar functionalities supported by the first network function and the second network function, dynamically modifiable thresholds and configuration synchronization may be applied to both the first network function and the second network function at the global level. As a result, due to adaptive global configuration management, the failure to the first network function may be less likely to result in an additional failure to the second network function, thereby resulting in an overall improvement in system performance.

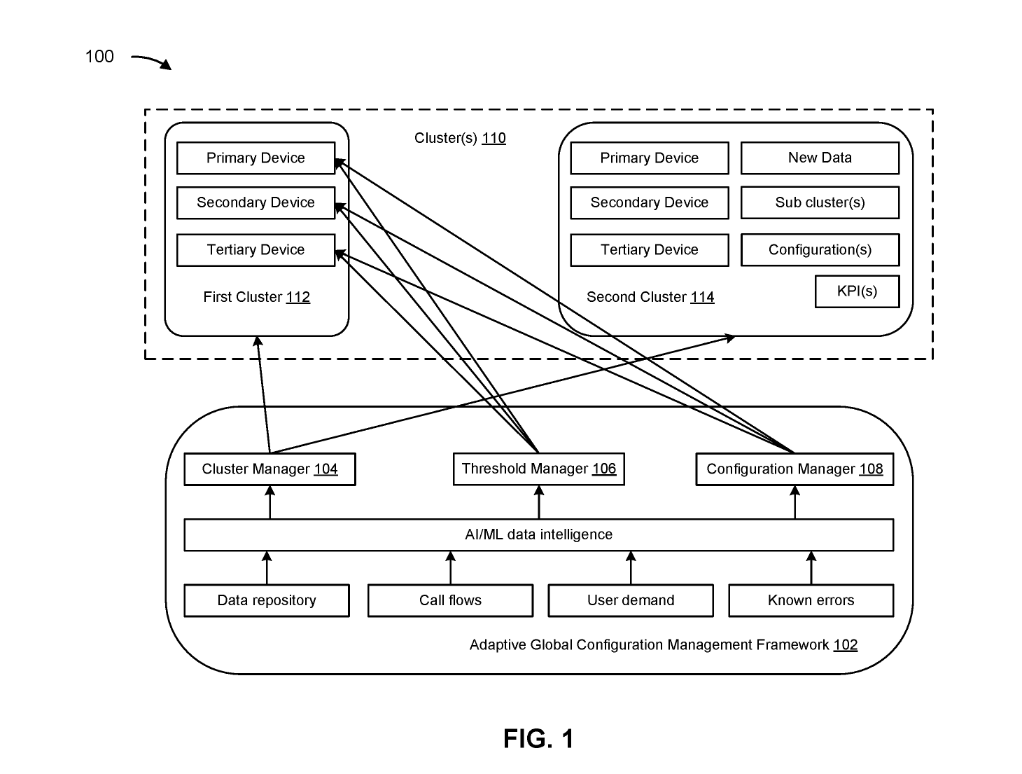

FIG. 1 is a diagram of an example 100 associated with an adaptive global configuration management framework 102. As shown in FIG. 1, example 100 includes a wireless communications network that contains the adaptive global configuration management framework 102 and one or more clusters 110. The adaptive global configuration management framework 102 may include a cluster manager 104, a threshold manager 106, and a configuration manager 108. The one or more clusters 110 may include a first cluster 112 and a second cluster 114. The adaptive global configuration management framework 102 may run on one or more devices in the wireless communications network. For example, the cluster manager 104, the threshold manager 106, and/or the configuration manager 108 may run on device in the wireless communications network, or the cluster manager 104, the threshold manager 106, and/or the configuration manager 108 may run on separate devices in the wireless communications network.

In some implementations, the first cluster 112 may include a first primary device, a first secondary device, and a first tertiary device. The second cluster 114 may include a second primary device, a second secondary device, and a second tertiary device. The second cluster 114 may include new data. The new data may include a customer information questionnaire which may be a spreadsheet, a comma-separated values (CSV) text file, or any type of database that contains configuration information about a particular network function or transport function. The second cluster 114 may include one or more sub clusters. The second cluster 114 may include one or more configurations. The second cluster 114 may be associated with one or more key performance indicators (KPIs).

In some implementations, the cluster manager 104, the threshold manager 106, and/or the configuration manager 108 may function using artificial intelligence and/or machine learning (AI/ML) data intelligence. The AI/ML data intelligence may be based on various inputs, which may include a data repository, call flows, user demand, and/or known errors. The cluster manager 104, the threshold manager 106, and/or the configuration manager 108 may use the AI/ML data intelligence to perform respective functions.

In some implementations, the cluster manager 104 may connect to all devices in the wireless communications network. The cluster manager 104 may read metadata associated with each device, and then the cluster manager 104 may dynamically create clusters of similarly functional devices (e.g., primary, secondary, and tertiary devices that serve the same function). For example, the cluster manager 104 may form the first cluster 112 and the second cluster 114. The cluster manager 104 may assign the first primary device, the first secondary device, and the first tertiary device to the first cluster 112, which may be based on the first primary device, the first secondary device, and the first tertiary device being associated with a first functionality. The cluster manager 104 may assign the second primary device, the second secondary device, and the second tertiary device to the first cluster 112, which may be based on the second primary device, the second secondary device, and the second tertiary device being associated with a second functionality. In some implementations, the cluster manager 104 may dynamically create sub clusters of devices. For example, the cluster manager 104 may create the one or more sub clusters for the second cluster 114, where the one or more sub clusters may include devices that are all associated with a same sub functionality. The cluster manager 104 may create a hybrid cluster. The hybrid cluster may be a combination of devices and other related configurations, where the hybrid cluster may include sub clusters.

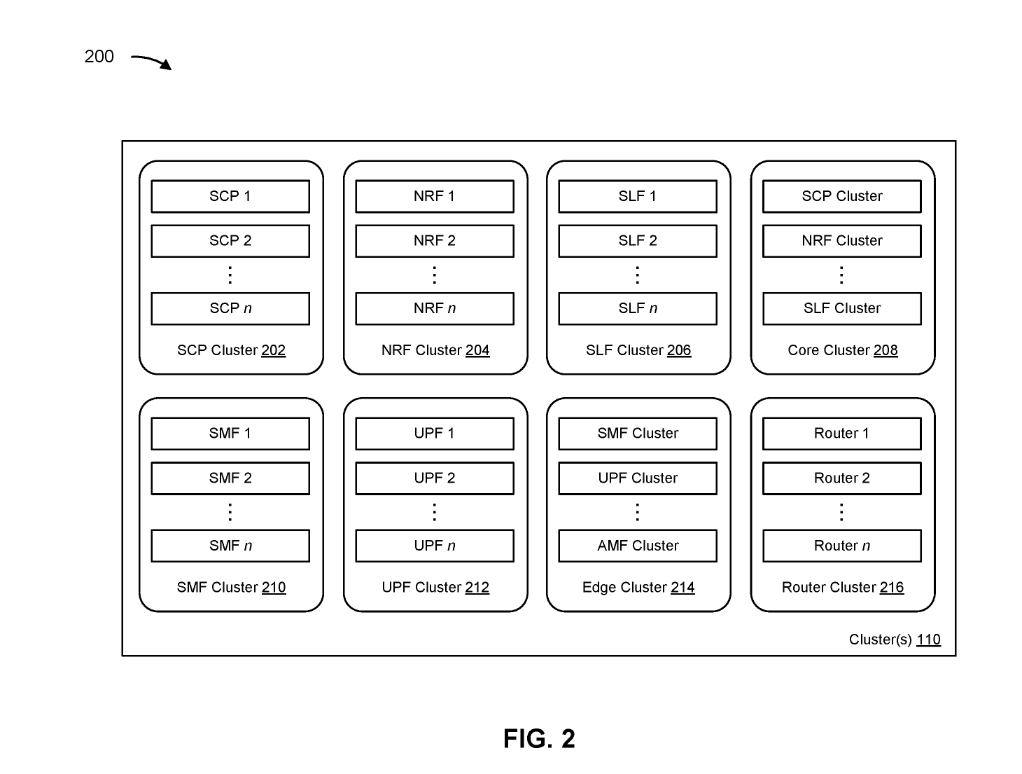

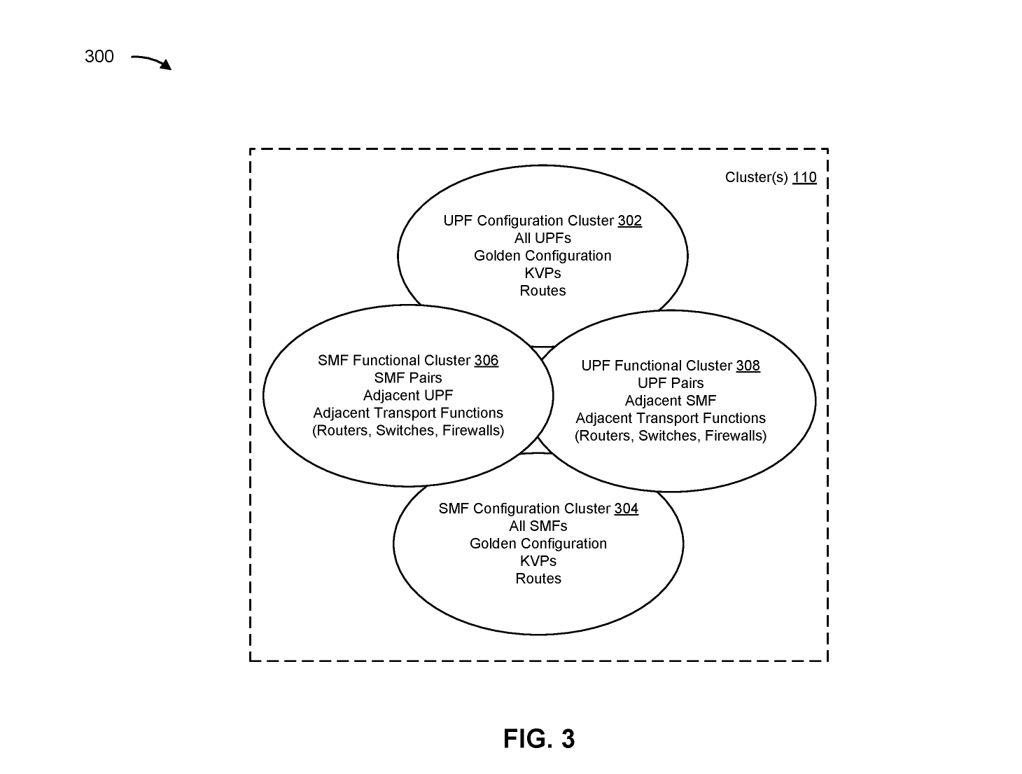

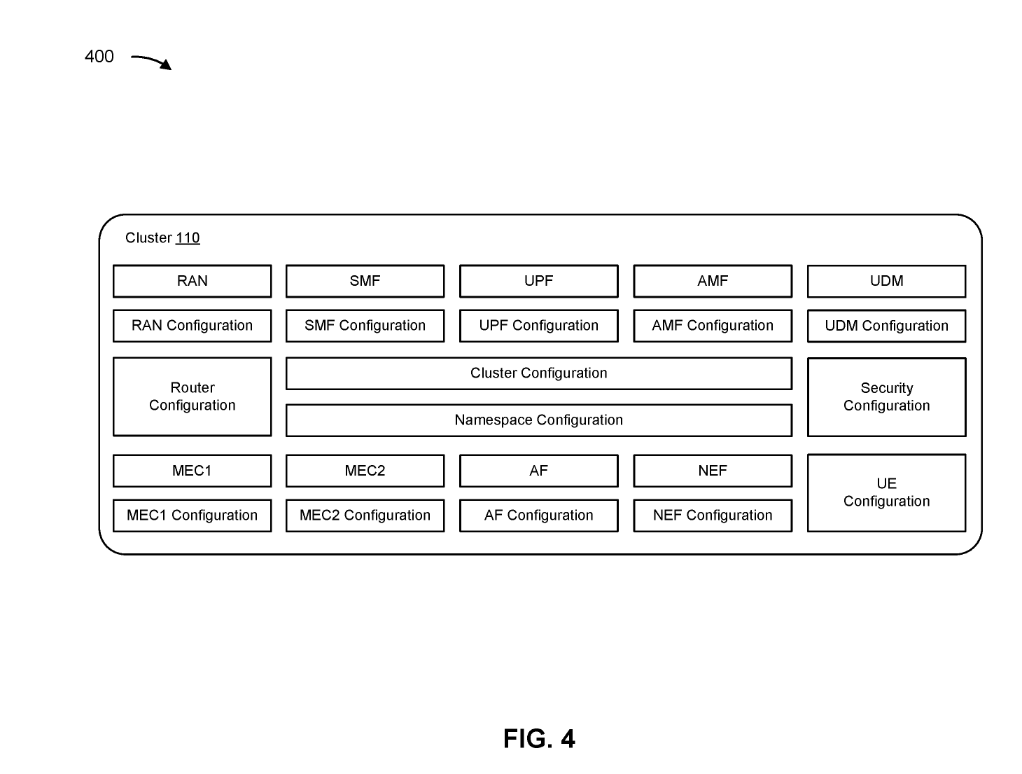

In some implementations, the cluster manager 104 may form clusters based on static homogeneous clustering (e.g., shown in FIG. 2), static heterogeneous clustering (e.g., as shown in FIG. 3), and/or dynamic hybrid clustering (e.g., as shown in FIG. 4).

In some implementations, the threshold manager 106 may detect threshold limits and dynamically adjust threshold limits based on load and a function availability. The threshold manager 106 may be able to dynamically adjust threshold limits for the first primary device, the first secondary device, and/or the first tertiary device associated with the first cluster 112. The threshold manager 106 may be able to dynamically adjust threshold limits for the second primary device, the second secondary device, and/or the second tertiary device associated with the second cluster 114. The threshold manager 106 may assign different threshold limits to different devices, even within the same cluster 110. The threshold manager 106 may be able to adjust threshold limits across the one or more clusters 110. For example, KPIs associated with the first cluster 112 may impact threshold limits in the second cluster 114, so the threshold manager 106 may adjust threshold limits for multiple clusters of devices.

In some implementations, the configuration manager 108 may be responsible for keeping configurations aligned between different devices within a cluster 110. The configuration manager 108 may align configurations between the first secondary device, and/or the first tertiary device associated with the first cluster 112. The configuration manager 108 may align configurations between the second primary device, the second secondary device, and/or the second tertiary device associated with the second cluster 114. When one configuration associated with one device within the cluster 110 is modified, other devices within the cluster 110 may be provided with an updated configuration, such that the configuration is consistent among all devices within the cluster 110. In some implementations, the configuration manager 108 may generate a hash (e.g., a numerical value) for each complete configuration and/or for each subset of configurations. The configuration manager 108 may generate the hash in a consistent manner, which may help to avoid missing configurations. The configuration manager 108 may maintain and/or execute various configurations (e.g., customer information questionnaires) when such configurations are present. The various configurations may be cluster specific, where different configurations may be applicable for different clusters 110.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

FIG. 2 is a diagram of an example 200 associated with static homogeneous clustering. As shown in FIG. 2, example 200 includes one or more clusters 110. The one or more clusters 110 may be associated with a static homogeneous clustering.

In some implementations, a cluster manager (e.g., cluster manager 104, as shown in FIG. 1) may create a cluster 110 of network functions based on static homogeneous clustering, where the network functions may be associated with a similar functionality. Metadata associated with each network function may indicate a functionality associated with the network function, and different network functions having similar functionalities may be clustered together. The cluster 110 may include one or more network functions, where the one or more network functions may include or be associated with an SMF, UPF, VCU, VDU, router, switch, firewall, network-layer core, edge device, and/or far edge device. The cluster 110 may be based on location, region, city, state, venue, and/or any other geographic representation. The cluster 110 may have a combination of devices, configuration files, customer information questionnaires, KPIs, and/or related fields.

As shown in FIG. 2, a wireless communications network may include a plurality of clusters 110. A service communication proxy (SCP) cluster 202 may include a plurality of SCP devices (e.g., SCP 1 to SCP n, where n is a positive integer). A network repository function (NRF) cluster 204 may include a plurality of NRF devices (e.g., NRF 1 to NRF n). A subscription location function (SLF) cluster 206 may include a plurality of SLF devices (e.g., SLF 1 to SLF n). A core cluster 208 may include an SCP cluster, an NRF cluster, and/or an SLF cluster. An SMF cluster 210 may include a plurality of SMF devices (e.g., SMF 1 to SMF n). A UPF cluster 212 may include a plurality of UPF devices (e.g., UPF 1 to UPF n). An edge cluster 214 may include an SMF cluster, a UPF cluster, and/or an access and mobility management function (AMF) cluster. A router cluster 216 may include a plurality of router devices (e.g., router 1 to router n).

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

FIG. 3 is a diagram of an example 300 associated with static heterogeneous clustering. As shown in FIG. 3, example 300 includes one or more clusters 110. The one or more clusters 110 may be associated with a static heterogeneous clustering.

In some implementations, a cluster manager (e.g., cluster manager 104, as shown in FIG. 1) may create a cluster 110 of network functions based on static heterogeneous clustering, where the network functions may be associated with a similar functionality. Network functions may belong to multiple clusters 110. For example, a given network function may be associated with both a first cluster and a second cluster. Clusters 110 may include overlapping network functions in some cases. A configuration cluster may enforce static configurations that are ubiquitous across similar network functions. A functional cluster may ensure that a transport configuration and a communication configuration is aligned for a given network function, such that the given network function is able to communicate with neighboring network functions. The functional cluster may include transport configurations on adjacent network functions and transport functions.

As shown in FIG. 3, a wireless communications network may include a plurality of clusters 110. A UPF configuration cluster 302 may be associated with one or more UPFs (e.g., all UPFs). The UPF configuration cluster 302 may be associated with a golden configuration, one or more key value pairs (KVPs), and/or one or more routes associated with the one or more UPFs. The UPF configuration cluster 302 may enforce static configurations that are universal across all similar UPFs. An SMF configuration cluster 304 may be associated with one or more SMFs (e.g., all SMFs). The SMF configuration cluster 304 may be associated with a golden configuration, one or more KVPs, and/or one or more routes associated with the one or more SMFs. The SMF configuration cluster 304 may enforce static configurations that are universal across all similar SMFs. An SMF functional cluster 306 may include one or more SMF pairs. The SMF functional cluster 306 may ensure that a transport and communication configuration is aligned for SMFs to communicate with neighboring UPFs (e.g., adjacent UPFs), where SMFs and UPFs may be associated with different clusters. The SMF functional cluster 306 may be associated with adjacent transport configurations (e.g., routers, switches, and/or firewalls). A UPF functional cluster 308 may include one or more UPF pairs. The UPF functional cluster 308 may ensure that a transport and communication configuration is aligned for UPFs to communicate with neighboring SMFs (e.g., adjacent SMFs), where UPFs and SMFs may be associated with different clusters. The UPF functional cluster 308 may be associated with adjacent transport configurations (e.g., routers, switches, and/or firewalls).

As indicated above, FIG. 3 is provided as an example. Other examples may differ from what is described with regard to FIG. 3. The number and arrangement of devices shown in FIG. 3 are provided as an example. In practice, there may be additional devices, fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) shown in FIG. 3 may perform one or more functions described as being performed by another set of devices shown in FIG. 3.

FIG. 4 is a diagram of an example 400 associated with dynamic hybrid clustering. As shown in FIG. 4, example 400 includes a cluster 110. The cluster 110 may be associated with a dynamic hybrid clustering.

In some implementations, a cluster manager (e.g., cluster manager 104, as shown in FIG. 1) may create a hybrid cluster 110 of network functions based on dynamic hybrid clustering, where the network functions may be associated with a similar functionality. The cluster manager may dynamically form the hybrid cluster 110 based on one or more configurations applied via a user query. For example, the user query may be performed in order to provide a new functionality to an enterprise in specific network functions. The cluster manager may have access to an entire network, so the cluster manager may be able to dynamically create the hybrid cluster 110 of network elements based on the user query. The hybrid cluster 110 may include network functions, customer information questionnaires, configurations, multi-access edge computing (MEC) devices, clusters, user equipment (UE) configurations, and/or security configurations.

In some implementations, a threshold manager (e.g., threshold manager 106, as shown in FIG. 1) may monitor specific parameters or configurations using a complex modeling with KPIs. The threshold manager may adjust thresholds of one or more network elements in the hybrid cluster 110 based on network load or other conditions.

In some implementations, a configuration manager (e.g., configuration manager 108, as shown in FIG. 1) may synchronize configurations across the one or more network elements in the hybrid cluster 110. Configurations may be replicated across the one or more network elements, and any updates to one configuration may be propagated to other network elements in the hybrid cluster 110.

As shown in FIG. 4, a wireless communications network may include the hybrid cluster 110, which may be dynamically formed based on the user query. The hybrid cluster 110 may include or be associated with a radio access network (RAN), a RAN configuration, an SMF, an SMF configuration, a UPF, a UPF configuration, an AMF, an AMF configuration, a unified data management (UDM), a UDM configuration, a router configuration, a security configuration, a cluster configuration, a namespace configuration, one or more MEC devices, one or more MEC configurations, an access function (AF), an AF configuration, a network exposure function (NEF), an NEF configuration, and/or a UE configuration.

As indicated above, FIG. 4 is provided as an example. Other examples may differ from what is described with regard to FIG. 4. The number and arrangement of devices shown in FIG. 4 are provided as an example. In practice, there may be additional devices, fewer devices, different devices, or differently arranged devices than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) shown in FIG. 4 may perform one or more functions described as being performed by another set of devices shown in FIG. 4.

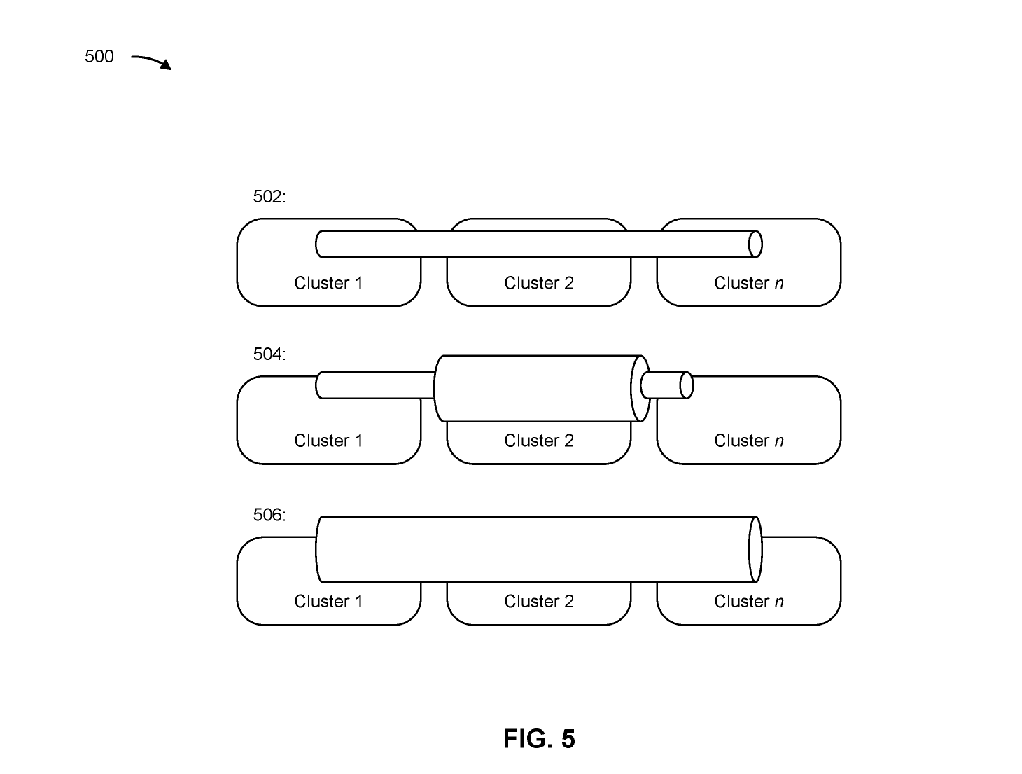

FIG. 5 is a diagram of an example 500 associated with a threshold manager.

As shown by reference number 502, for one or more clusters (e.g., cluster 1 to cluster n), a threshold manager (e.g., threshold manager 106, as shown in FIG. 1) may statically set one or more thresholds to specific values. For example, the threshold manager may statically set a threshold for each cluster. All thresholds may be statically set to specific values. When one device threshold is altered for a given cluster, thresholds for other clusters may not be adjusted (e.g., no knowledge of impact when one device threshold is altered).

As shown by reference number 504, for one or more clusters (e.g., cluster 1 to cluster n), a threshold of one device in a cluster may be altered. The threshold of the one device may be altered without knowledge of an impact on neighboring devices within the same cluster. The threshold manager may automatically thresholds in other devices within the same cluster. In other words, when one threshold is changed for one device within a given cluster, thresholds may be similarly changed for other devices within the given cluster. In some cases, when the threshold manager sets the same threshold in all devices in the given cluster, a bottleneck may be created when traffic is passed to other network functions or clusters, which may lead to congestion.

As shown by reference number 506, for one or more clusters (e.g., cluster 1 to cluster n), the threshold manager may have a complete cluster topology view. The threshold manager may have integration with call flows and/or user demand, and the threshold manager may be able to predict thresholds from possible congestions in other clusters using AI/ML intelligence of an adaptive global configuration management framework. The threshold manager may modify thresholds in other clusters of devices accordingly when thresholds in other clusters are altered, thereby ensuring that bottlenecks are not created in specific clusters.

As indicated above, FIG. 5 is provided as an example. Other examples may differ from what is described with regard to FIG. 5. The number and arrangement of devices shown in FIG. 5 are provided as an example. In practice, there may be additional devices, fewer devices, different devices, or differently arranged devices than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) shown in FIG. 5 may perform one or more functions described as being performed by another set of devices shown in FIG. 5.

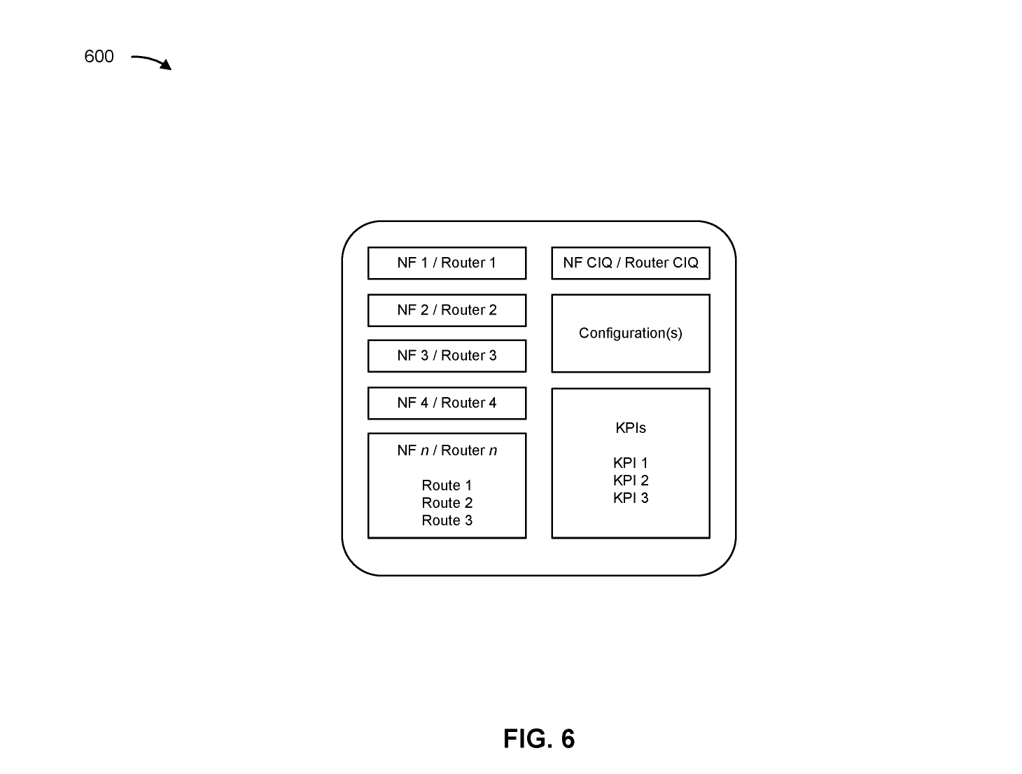

FIG. 6 is a diagram of an example 600 associated with a configuration manager.

In some implementations, a configuration manager (e.g., configuration manager 108, as shown in FIG. 1) may manage clusters and inter-clusters of functions to maintain configuration synchronization across different clusters. The configuration manager may perform intra-cluster functions. The configuration manager may identify sources. For example, the configuration manager may identify a first customer information questionnaire (CIQ), which may be associated with sheet 1, sheet 2, and sheet n. The configuration manager may identify a second customer information questionnaire, which may be associated with sheet 1, sheet 2, and sheet n. The configuration manager may identify destination sources. The configuration manager may identify a first network function (NF) or a first router, which may be associated with a first configuration and a first parameter. The configuration manager may identify a second network function or a second router, which may be associated with a second configuration and a second parameter. The configuration manager may identify KPIs. For example, the configuration manager may identify a first customer information questionnaire value, which may be associated with the first configuration and a first KPI. The configuration manager may identify a second customer information questionnaire value, which may be associated with the second configuration and a second KPI.

In some implementations, the configuration manager may look for changes in the sources, and then implement the changes in the destinations, which may be in accordance with the configuration synchronization across different clusters. The configuration manager may monitor the KPIs, and when one or more KPIs deviate from certain levels, the configuration manager may modify corresponding customer information questionnaires. The configuration manager may detect configuration drifts and resulting impacts on performance. The configuration manager may synchronize configuration drifts from top down (e.g., from source to destination). Alternatively, configurations may be fine-tuned directly in a network function and a customer information questionnaire may be updated, such that other network functions in the same cluster are updated as well (e.g., from destination to source). The configuration manager may develop a complex relation or modeling between customer information questionnaires, configurations in routers, and/or KPIs within and across clusters. The configuration manager may perform a function modeling based on additional parameters that affect the performance, such as location, type of customer, and/or time. The configuration manager may ensure that all routers configurations for certain clusters, and when deviations are present between configurations, the configuration manager may synchronize the configurations across clusters. The configuration manager may monitor KPIs in other clusters and modify customer information questionnaires in peer clusters.

As shown in FIG. 6, the configuration manager may maintain configuration synchronization across one or more network functions or one or more routers, which may include a first network function or first router, a second network function or second router, a third network function or third router, a fourth network function or fourth router. The configuration manager may maintain configuration synchronization across network function customer information questionnaires or router customer information questionnaires. The configuration manager may maintain configuration synchronization across multiple configurations. The configuration manager may maintain configuration synchronization across multiple KPIs, which may include a first KPI, a second KPI, and/or a third KPI. The configuration synchronization may be within one cluster (e.g., intra-cluster configuration synchronization) or across multiple clusters (e.g., inter-cluster configuration synchronization).

As indicated above, FIG. 6 is provided as an example. Other examples may differ from what is described with regard to FIG. 6. The number and arrangement of devices shown in FIG. 6 are provided as an example. In practice, there may be additional devices, fewer devices, different devices, or differently arranged devices than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) shown in FIG. 6 may perform one or more functions described as being performed by another set of devices shown in FIG. 6.

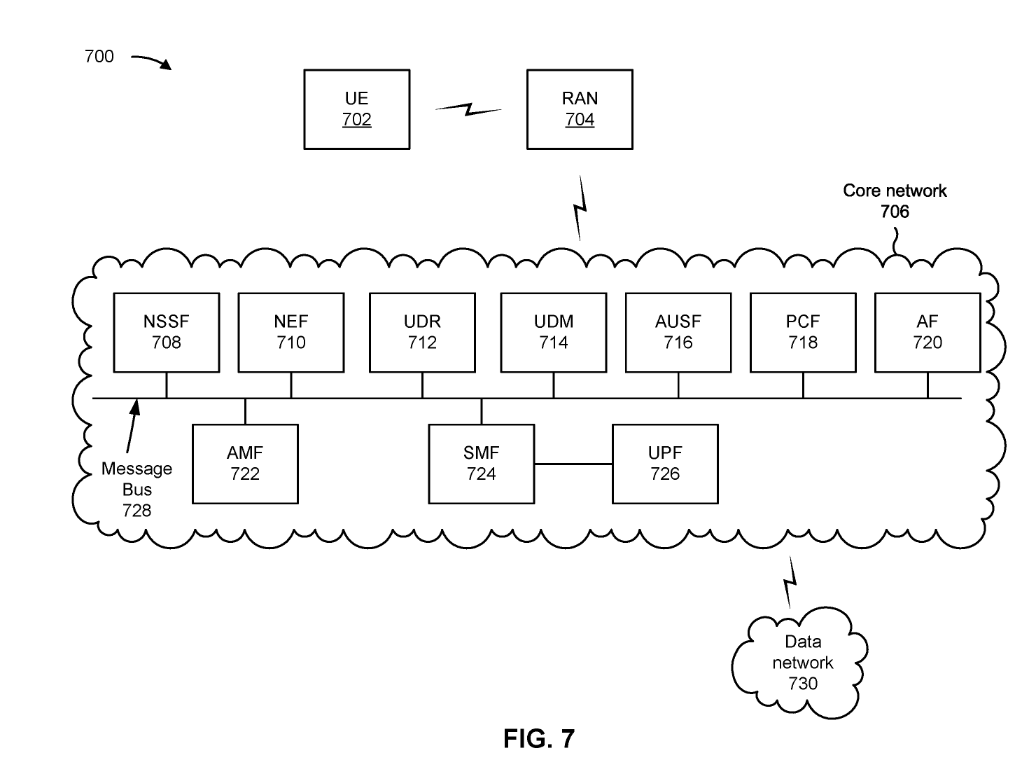

FIG. 7 is a diagram of an example environment 700 in which systems and/or methods described herein may be implemented. As shown in FIG. 7, example environment 700 may include a UE 702, a RAN 704, a core network 706, and a data network 730. Devices and/or networks of example environment 700 may interconnect via wired connections, wireless connections, or a combination of wired and wireless connections.

The UE 702 may include one or more devices capable of receiving, generating, storing, processing, and/or providing information, such as information described herein. For example, the UE 702 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The RAN 704 may support, for example, a cellular radio access technology (RAT). The RAN 704 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 702. A base station may be a disaggregated base station. The disaggregated base station may be configured to utilize a protocol stack that is physically or logically distributed among two or more nodes, which may include a radio unit (RU), a distributed unit (DU), and a centralized unit (CU). The RAN 704 may transfer traffic between the UE 702 (e.g., using a cellular RAT), one or more base stations (e.g., using a wireless interface or a backhaul interface, such as a wired backhaul interface), and/or the core network 706. The RAN 704 may provide one or more cells that cover geographic areas.

In some implementations, the RAN 704 may perform scheduling and/or resource management for the UE 702 covered by the RAN 704 (e.g., the UE 702 covered by a cell provided by the RAN 704). In some implementations, the RAN 704 may be controlled or coordinated by a network controller, which may perform load balancing, network-level configuration, and/or other operations. The network controller may communicate with the RAN 704 via a wireless or wireline backhaul. In some implementations, the RAN 704 may include a network controller, a self-organizing network (SON) module or component, or a similar module or component. In other words, the RAN 704 may perform network control, scheduling, and/or network management functions (e.g., for uplink, downlink, and/or sidelink communications of the UE 702 covered by the RAN 704).

In some implementations, the core network 706 may include an example functional architecture in which systems and/or methods described herein may be implemented. For example, the core network 706 may include an example architecture of a 5G next generation (NG) core network included in a 5G wireless telecommunications system. While the example architecture of the core network 706 shown in FIG. 7 may be an example of a service-based architecture, in some implementations, the core network 706 may be implemented as a reference-point architecture and/or a 4G core network, among other examples.

As shown in FIG. 7, the core network 706 may include a number of functional elements. The functional elements may include, for example, a network slice selection function (NSSF) 708, an NEF 710, a unified data repository (UDR) 712, a UDM 714, an authentication server function (AUSF) 716, a policy and control function (PCF) 718, an AF 720, an AMF 722, an SMF 724, and/or a UPF 726. These functional elements may be communicatively connected via a message bus 728. Each of the functional elements shown in FIG. 7 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 708 may include one or more devices that select network slice instances for the UE 702. The NSSF 708 may allow an operator to deploy multiple substantially independent end-to-end networks potentially with the same infrastructure. In some implementations, each slice may be customized for different services. The NEF 710 may include one or more devices that support exposure of capabilities and/or events in the wireless telecommunications system to help other entities in the wireless telecommunications system discover network services.

The UDR 712 may include one or more devices that provide a converged repository, which may be used by network functions to store data. For example, a converged repository of subscriber information may be used to service a number of network functions. The UDM 714 may include one or more devices to store user data and profiles in the wireless telecommunications system. The UDM 714 may generate authentication vectors, perform user identification handling, perform subscription management, and perform other various functions. The AUSF 716 may include one or more devices that act as an authentication server and support the process of authenticating the UE 702 in the wireless telecommunications system.

The PCF 718 may include one or more devices that provide a policy framework that incorporates network slicing, roaming, packet processing, and/or mobility management, among other examples. The AF 720 may include one or more devices that support application influence on traffic routing, access to the NEF 710, and/or policy control, among other examples. The AMF 722 may include one or more devices that act as a termination point for non-access stratum (NAS) signaling and/or mobility management, among other examples. The SMF 724 may include one or more devices that support the establishment, modification, and release of communication sessions in the wireless telecommunications system. For example, the SMF 724 may configure traffic steering policies at the UPF 726 and/or may enforce UE internet protocol (IP) address allocation and policies, among other examples. The UPF 726 may include one or more devices that serve as an anchor point for intra-RAT and/or inter-RAT mobility. The UPF 726 may apply rules to packets, such as rules pertaining to packet routing, traffic reporting, and/or handling user plane QoS, among other examples. The message bus 728 may represent a communication structure for communication among the functional elements. In other words, the message bus 728 may permit communication between two or more functional elements.

The data network 730 may include one or more wired and/or wireless data networks. For example, the data network 730 may include an Internet Protocol multimedia subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 7 are provided as an example. In practice, there may be additional devices and/or networks, fewer devices and/or networks, different devices and/or networks, or differently arranged devices and/or networks than those shown in FIG. 7. Furthermore, two or more devices shown in FIG. 7 may be implemented within a single device, or a single device shown in FIG. 7 may be implemented as multiple, distributed devices. Additionally, or alternatively, a set of devices (e.g., one or more devices) of example environment 700 may perform one or more functions described as being performed by another set of devices of example environment 700.

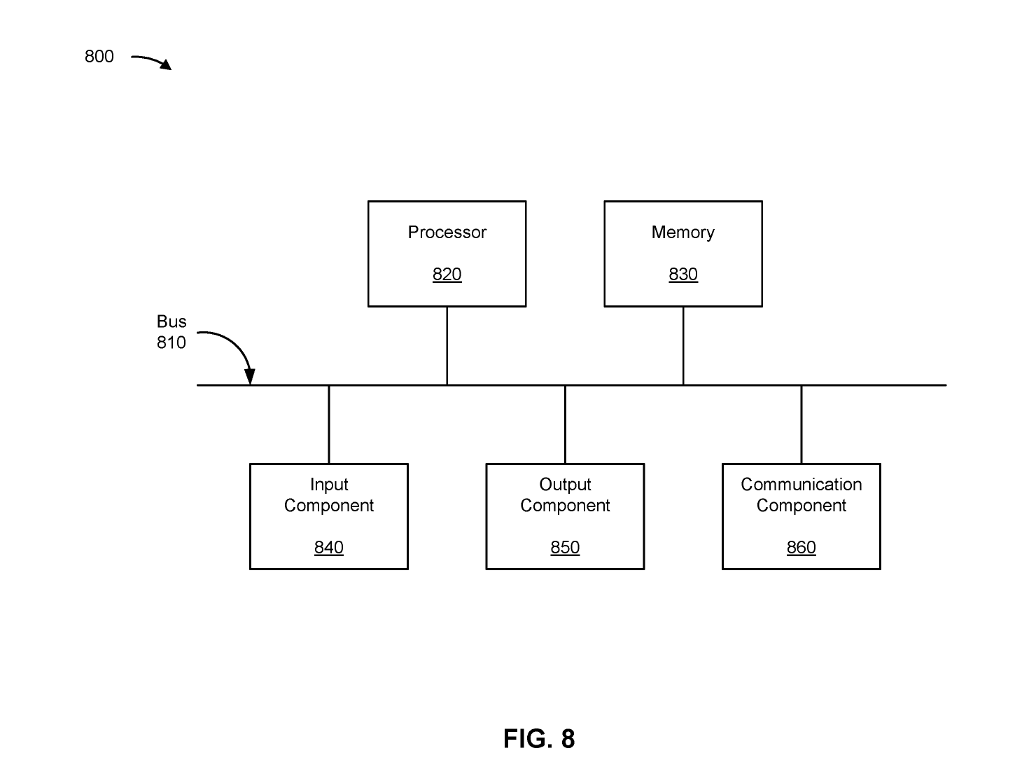

FIG. 8 is a diagram of example components of a device 800 associated with creating clusters of network functions in a wireless network. The device 800 may correspond to a cluster manager (e.g., cluster manager 104), a threshold manager (e.g., threshold manager 106), and/or a configuration manager (e.g., configuration manager 108) associated with an adaptive global configuration management framework (e.g., adaptive global configuration management framework 102). In some implementations, the device may include one or more devices 800 and/or one or more components of the device 800. As shown in FIG. 8, the device 800 may include a bus 810, a processor 820, a memory 830, an input component 840, an output component 850, and/or a communication component 860.

The bus 810 may include one or more components that enable wired and/or wireless communication among the components of the device 800. The bus 810 may couple together two or more components of FIG. 8, such as via operative coupling, communicative coupling, electronic coupling, and/or electric coupling. For example, the bus 810 may include an electrical connection (e.g., a wire, a trace, and/or a lead) and/or a wireless bus. The processor 820 may include a central processing unit, a graphics processing unit, a microprocessor, a controller, a microcontroller, a digital signal processor, a field-programmable gate array, an application-specific integrated circuit, and/or another type of processing component. The processor 820 may be implemented in hardware, firmware, or a combination of hardware and software. In some implementations, the processor 820 may include one or more processors capable of being programmed to perform one or more operations or processes described elsewhere herein.

The memory 830 may include volatile and/or nonvolatile memory. For example, the memory 830 may include random access memory (RAM), read only memory (ROM), a hard disk drive, and/or another type of memory (e.g., a flash memory, a magnetic memory, and/or an optical memory). The memory 830 may include internal memory (e.g., RAM, ROM, or a hard disk drive) and/or removable memory (e.g., removable via a universal serial bus connection). The memory 830 may be a non-transitory computer-readable medium. The memory 830 may store information, one or more instructions, and/or software (e.g., one or more software applications) related to the operation of the device 800. In some implementations, the memory 830 may include one or more memories that are coupled (e.g., communicatively coupled) to one or more processors (e.g., processor 820), such as via the bus 810. Communicative coupling between a processor 820 and a memory 830 may enable the processor 820 to read and/or process information stored in the memory 830 and/or to store information in the memory 830.

The input component 840 may enable the device 800 to receive input, such as user input and/or sensed input. For example, the input component 840 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 850 may enable the device 800 to provide output, such as via a display, a speaker, and/or a light-emitting diode. The communication component 860 may enable the device 800 to communicate with other devices via a wired connection and/or a wireless connection. For example, the communication component 860 may include a receiver, a transmitter, a transceiver, a modem, a network interface card, and/or an antenna.

The device 800 may perform one or more operations or processes described herein. For example, a non-transitory computer-readable medium (e.g., memory 830) may store a set of instructions (e.g., one or more instructions or code) for execution by the processor 820. The processor 820 may execute the set of instructions to perform one or more operations or processes described herein. In some implementations, execution of the set of instructions, by one or more processors 820, causes the one or more processors 820 and/or the device 800 to perform one or more operations or processes described herein. In some implementations, hardwired circuitry may be used instead of or in combination with the instructions to perform one or more operations or processes described herein. Additionally, or alternatively, the processor 820 may be configured to perform one or more operations or processes described herein. Thus, implementations described herein are not limited to any specific combination of hardware circuitry and software.

The number and arrangement of components shown in FIG. 8 are provided as an example. The device 800 may include additional components, fewer components, different components, or differently arranged components than those shown in FIG. 8. Additionally, or alternatively, a set of components (e.g., one or more components) of the device 800 may perform one or more functions described as being performed by another set of components of the device 800.

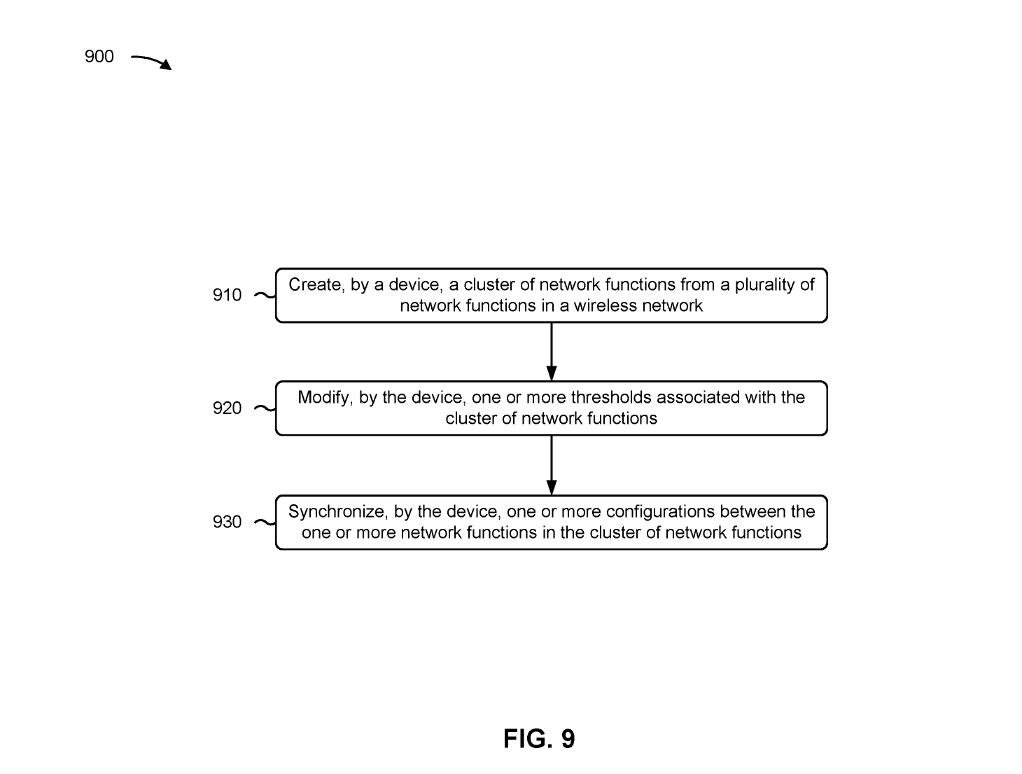

FIG. 9 is a flowchart of an example process 900 associated with creating clusters of network functions in a wireless network. In some implementations, one or more process blocks of FIG. 9 may be performed by a device, such as a cluster manager (e.g., cluster manager 104), a threshold manager (e.g., threshold manager 106), and/or a configuration manager (e.g., configuration manager 108) associated with an adaptive global configuration management framework (e.g., adaptive global configuration management framework 102). In some implementations, one or more process blocks of FIG. 9 may be performed by another device or a group of devices separate from or including the cluster manager, the threshold manager, and/or the configuration manager. Additionally, or alternatively, one or more process blocks of FIG. 9 may be performed by one or more components of device 800, such as processor 820, memory 830, input component 840, output component 850, and/or communication component 860.

As shown in FIG. 9, process 900 may include creating, by the device, a cluster of network functions from a plurality of network functions in a wireless network (block 910). The cluster of network functions may include one or more network functions that are associated with a same network functionality. The device may identify metadata for each network function in the plurality of network functions, where the metadata may indicate a functionality associated with the network function. The device may create the cluster of network functions based on metadata associated with each network function in the cluster of network functions. The device may create cluster of network functions based on static homogeneous clustering, static heterogeneous clustering, or dynamic hybrid clustering. The device may create the cluster of network functions based on a type of network function. The device may create the cluster of network functions based on a location associated with the one or more network functions, a region associated with the one or more network functions, and/or a venue associated with the one or more network functions. The cluster of network functions may include an SCP device, an NRF device, an SLF device, an SMF device, a UPF device, and/or an AMF device. The cluster of network functions may be associated with configuration files, customer information questionnaires, KPIs, and/or related fields.

In some implementations, the cluster of network functions may be a configuration cluster that enforces static configurations across the one or more network functions. The cluster of network functions may be a transport cluster that ensures that transport configurations and communication configurations are aligned for the one or more network functions to enable communication with network functions in another cluster. The cluster of network functions may be a first cluster of network functions, where a network function associated with the first cluster may also be associated with a second cluster of network functions. The device may receive a user query that indicates a desired cluster configuration, where the cluster of network functions may be created based on the user query.

As shown in FIG. 9, process 900 may include modifying, by the device, one or more thresholds associated with the cluster of network functions (block 920). Each network function in the cluster of network functions may be associated with a respective threshold of the one or more thresholds. The device may modify the one or more thresholds associated with the cluster of network functions based on a network load and/or a function availability. In some implementations, the cluster of network functions may be a first cluster of network functions. The device may modify the one or more thresholds associated with the first cluster of network functions based on one or more network conditions associated with a second cluster of network functions.

As shown in FIG. 9, process 900 may include synchronizing, by the device, one or more configurations between the one or more network functions in the cluster of network functions (block 930). The device may identify an updated configuration associated with a network function in the cluster of network functions. The device may determine that the updated configuration is different than configurations associated with other network functions in the cluster of network functions. The device may provide the updated configuration to the other network functions in the cluster of network functions.

Although FIG. 9 shows example blocks of process 900, in some implementations, process 900 may include additional blocks, fewer blocks, different blocks, or differently arranged blocks than those depicted in FIG. 9. Additionally, or alternatively, two or more of the blocks of process 900 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
creating, by a device, a cluster of network functions from a plurality of network functions in a wireless network, wherein the cluster of network functions includes one or more network functions that are associated with a same network functionality;
modifying, by the device, one or more thresholds associated with the cluster of network functions, wherein each network function in the cluster of network functions is associated with a respective threshold of the one or more thresholds; and
synchronizing, by the device, one or more configurations between the one or more network functions in the cluster of network functions.

2. The method of claim 1, wherein creating the cluster of network functions comprises:
identifying, by the device, metadata for each network function in the plurality of network functions, wherein the metadata indicates a functionality associated with the network function; and
creating, by the device, the cluster of network functions based on metadata associated with each network function in the cluster of network functions.

3. The method of claim 1, wherein creating the cluster of network functions is based on static homogeneous clustering, static heterogeneous clustering, or dynamic hybrid clustering.

4. The method of claim 1, wherein creating the cluster of network functions is based on a type of network function.

5. The method of claim 1, wherein creating the cluster of network functions is based on one or more of: a location associated with the one or more network functions, a region associated with the one or more network functions, or a venue associated with the one or more network functions.

6. The method of claim 1, wherein the cluster of network functions includes one or more of: a service communication proxy (SCP) device, a network repository function (NRF) device, a subscription location function (SLF) device, a session management function (SMF) device, a user plane function (UPF) device, or an access and mobility management function (AMF).

7. The method of claim 1, wherein the cluster of network functions is associated with one or more of: configuration files, customer information questionnaires, key performance indicators (KPIs), or related fields.

8. The method of claim 1, wherein the cluster of network functions is a configuration cluster that enforces static configurations across the one or more network functions.

9. The method of claim 1, wherein the cluster of network functions is a transport cluster that ensures that transport configurations and communication configurations are aligned for the one or more network functions to enable communication with network functions in another cluster.

10. The method of claim 1, wherein the cluster of network functions is a first cluster of network functions, and wherein a network function associated with the first cluster is also associated with a second cluster of network functions.

11. The method of claim 1, further comprising:
receiving, by the device, a user query that indicates a desired cluster configuration, wherein the cluster of network functions is created based on the user query.

12. The method of claim 1, wherein modifying the one or more thresholds associated with the cluster of network functions is based on one or more of: a network load or a function availability.

13. The method of claim 1, wherein the cluster of network functions is a first cluster of network functions, and wherein modifying the one or more thresholds associated with the first cluster of network functions is based on one or more network conditions associated with a second cluster of network functions.

14. The method of claim 1, wherein synchronizing the one or more configurations comprises:
identifying, by the device, an updated configuration associated with a network function in the cluster of network functions;
determining, by the device, that the updated configuration is different than configurations associated with other network functions in the cluster of network functions; and
providing, by the device, the updated configuration to the other network functions in the cluster of network functions.

15. A device, comprising:
one or more processors configured to:
create a cluster of network functions from a plurality of network functions in a wireless network, wherein the cluster of network functions includes one or more network functions that are associated with a same network functionality;
modify one or more thresholds associated with the cluster of network functions, wherein each network function in the cluster of network functions is associated with a respective threshold of the one or more thresholds; and
synchronize one or more configurations between the one or more network functions in the cluster of network functions.

16. The device of claim 15, wherein the one or more processors, to create the cluster of network functions, are configured to:
identify metadata for each network function in the plurality of network functions, wherein the metadata indicates a functionality associated with the network function; and
create the cluster of network functions based on metadata associated with each network function in the cluster of network functions.

17. The device of claim 15, wherein the one or more processors, to create the cluster of network functions, are configured to:
create the cluster of network functions based on static homogeneous clustering, static heterogeneous clustering, or dynamic hybrid clustering;
create the cluster of network functions based on a type of network function; or
create the cluster of network functions based on one or more of: a location associated with the one or more network functions, a region associated with the one or more network functions, or a venue associated with the one or more network functions.

18. The device of claim 15, wherein:
the cluster of network functions is associated with one or more of: configuration files, customer information questionnaires, key performance indicators (KPIs), or related fields;
the cluster of network functions is a configuration cluster that enforces static configurations across the one or more network functions;
the cluster of network functions is a transport cluster that ensures that transport configurations and communication configurations are aligned for the one or more network functions to enable communication with network functions in another cluster; or
the cluster of network functions is a first cluster of network functions, and wherein a network function associated with the first cluster is also associated with a second cluster of network functions.

19. The device of claim 15, wherein the one or more processors, to synchronize the one or more configurations, are configured to:
identify an updated configuration associated with a network function in the cluster of network functions;
determine that the updated configuration is different than configurations associated with other network functions in the cluster of network functions; and
provide the updated configuration to the other network functions in the cluster of network functions.

20. A non-transitory computer-readable medium storing a set of instructions, the set of instructions comprising:
one or more instructions that, when executed by one or more processors of a device, cause the device to:
create a cluster of network functions from a plurality of network functions in a wireless network, wherein the cluster of network functions includes one or more network functions that are associated with a same network functionality;
modify one or more thresholds associated with the cluster of network functions, wherein each network function in the cluster of network functions is associated with a respective threshold of the one or more thresholds; and
synchronize one or more configurations between the one or more network functions in the cluster of network functions.
